(19) United States
(12) Patent Application Publication
(10) Pub. No.: US 2010/0198871 A1
(43) Pub. Date: Aug. 5, 2010

(54) INTUITIVE FILE SHARING WITH TRANSPARENT SECURITY

(75) Inventors: Marc D. Stiegler, Kingman, AZ (US); Alan H. Karp, Palo Alto, CA (US); Mark S. Miller, Sunnyvale, CA (US); Tyler J. Close, Menlo Park, CA (US)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/364,806

(22) Filed: Feb. 3, 2009

(51) Int. Cl. G06F 17/30

(52) U.S. Cl. 707/783; 709/206

(57) ABSTRACT

A file sharing system includes authorization-based security to control access to shared files; and a synchronizer which uses the authorization-based security to monitor the shared files for changes and propagating the changes according to sharing relationships. A method for file sharing includes using authorization-based security to control access to a shared file; and monitoring the shared file for changes using a synchronizer which incorporates the authorization-based security to access the shared file.

### BACKGROUND

Sharing information between individuals and organizations has become a fundamental to modern society. Today, much of the available information is in the form of computer files. Consequently, an intuitive and secure system for sharing computer files is increasingly important. Many of these files are used in a collaborative setting in which the files are reviewed and edited by a number of people. Ideally, the file sharing system would include the ability to autonomously propagate these changes, detect editing conflicts, and escalate issues which are best solved by the human users.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a diagram of illustrative file sharing using computer technology, according to one embodiment of principles described herein.

FIG. 2 is a diagram of an illustrative system for intuitive file sharing using unobtrusive security measures, according to one embodiment of principles described herein.

FIG. 3 is a diagram of one illustrative method for initiating intuitive file sharing, according to one embodiment of principles described herein.

FIG. 4 is an illustrative screen shot of an email-like interface for intuitive file sharing, according to one embodiment of principles described herein.

FIG. 5 is an illustrative screen shot which shows an inbox which displays file sharing actions, according to one embodiment of principles described herein.

FIG. 6 is an illustrative screen shot which shows active file shares, according to one embodiment of principles described herein.

FIG. 7 is a flow chart which shows an illustrative method for intuitive file sharing with transparent security, according to one embodiment of principles described herein.

FIG. 8 is a flow chart which shows an illustrative method for identifying and resolving conflicts within a file sharing system, according to one embodiment of principles described herein.

Throughout the drawings, identical reference numbers designate similar, but not necessarily identical, elements.

### DETAILED DESCRIPTION

Many methods for securely sharing files require the use of access control lists and identity authentication systems such as user names and passwords. Other methods only work for immutable files, i.e., files whose content is not expected to change, and others are unable to keep track of edit conflicts that may arise as a result of multiple editors working simultaneously. The challenge is to find a means for secure file sharing, for files whose content may change over time, without extraneous security-oriented activities (thus creating a more pleasurable user experience), while ensuring that the sharing users are alerted to edit conflicts, reducing the risk that they will lose work.

There are several methods of sharing files. One method is to use access control lists on a file to specify identities allowed access to the file, and to specify what rights that identity has (for example, read-only or read-write access). These lists are attached to the file and specify who can and can't perform certain functions with that particular file. A second method is to place the file into a sharable repository, and place the access control list on the repository. A third method is to place the file in a version management system and place an access control list on the version management repository. A fourth method is to simply send the file as an email attachment, and if one wants to grant edit authority, mention in the attached email that, after you are done editing, email it back to the originator and the originator will update the file. A fifth method is to use a peer-to-peer file sharing system to distribute the files from all the machines that currently have exported copies to all the machines requesting copies.

All of these approaches either require user interaction with security-oriented machinery that has nothing to do with the file sharing and editing, or only work with immutable files, or cannot detect edit conflicts.

The approach presented in the specification and accompanying figures creates a significantly more pleasant user experience by eliminating the need for interacting explicitly with security machinery. There are no usernames to remember, passwords to forget, certificate authorities to study, or confusing security dialog boxes to misunderstand.

According to one illustrative embodiment, securely self-authorizing Uniform Resource Locators (URLs) are used to designate files to be sent and synchronized between share participants. By using an email metaphor to send and synchronize using such securely self-authorizing URLs, a file sharing system is created in which no special security-oriented actions (such as setting user identities in an access control list, or logging in with a username-password) need be taken by the user to share the files. Further, synchronizers operate in the background to detect changes and editing activities in the shared files. By exploiting the synchronizer's awareness of editing activity, the file sharing system detects edit conflicts and assists the user in resolving such conflicts.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

According to one illustrative embodiment, the file sharing system and method described below is termed Simple Cooperative File Sharing System, or SCoopFS.

Throughout the specification and appended claims the term “initiator” or “originator” refers to an individual who has a file or has access to a file and chooses to share it. A “recipient” is a person who has been chosen by an initiator to have access to a shared file. The terms “initiator” and “recipient” always designate a pair-wise relationship. For example, a first initiator can share a file with a first recipient. The first recipient can then share the file with someone else, thereby becoming a second initiator. The first initiator can remain completely oblivious to the first recipient's subsequent sharing. Each individual knows and can control his own direct sharing relationships without a need to understand the overall view other interactions within the system.

Once the file sharing has been set up, the distinction between the initiator and the recipient become less important. Rather, the responsibility for merging changes in the documents and resolving editing conflicts (“the merge master”) can distinguish one participant from another. The role of merge master is independent of the initial roles of the parties and may be assigned to either an initiator or recipient. In some collaborative environments, the merge master role may be distributed among some or all of the participants. In other environments, the participants may select one individual to receive all the relevant changes to the shared file and merge them into a single updated file. This updated file can then be propagated among the rest of the participants.

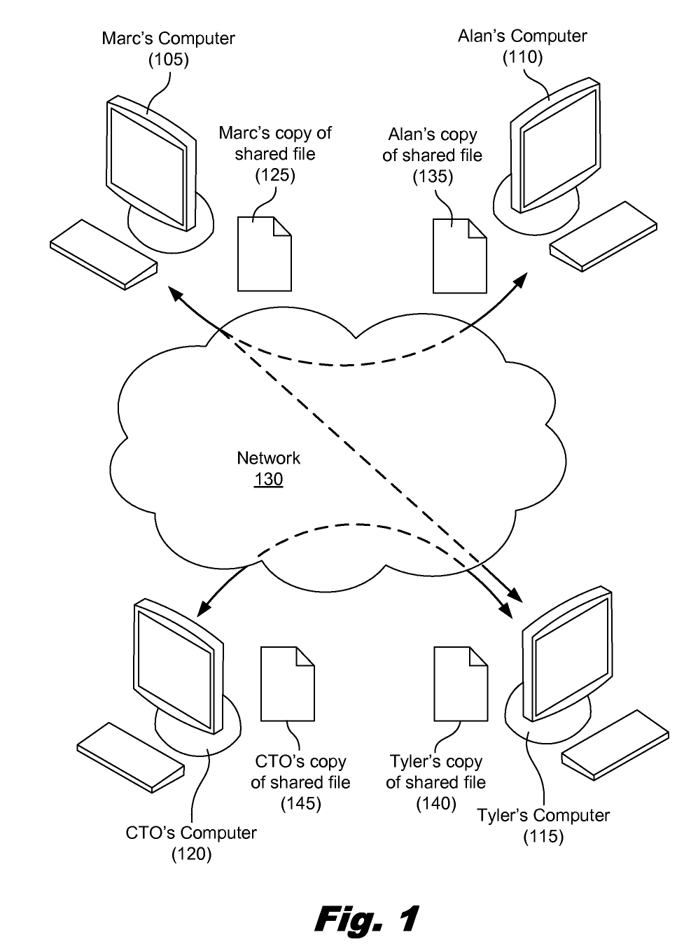

FIG. 1 is a diagram of illustrative file sharing using computer technology. In FIG. 1, four computers (105, 110, 115, 120) are connected to a network (130) which passes electronic information between the computers. In modern communications systems, there may be any number of computers or other electronic devices connected to a network (130). For clarity of illustration, only four computers (105, 110, 115, 120) are shown. The network (130) may be comprised of a number of interconnected systems such as personal, local, and wide area networks, the Internet, wireless networks, intranets, virtual private networks and other systems. The network (130) may include a number of individual components including, but not limited to, network interface cards, repeaters, hubs, bridges, switches, routers, transmitters/receivers, firewalls and other components.

A first computer user (“Marc”) has saved a file (125) on a first computer (“Marc's computer”) (105) which he wishes to share with his colleagues, Alan and Tyler. In this particular case, Marc and Alan are working on a cooperative project which includes revising and updating the information contained in the file (125). For example, file (125) may be a software specification for a software product that Marc and Alan are creating. Tyler may be less involved in the project and, while Marc wants Tyler to be informed of the progress of the project, Marc does not expect Tyler to edit the file. For example, Tyler may be a supervisor or may have previously developed a specific module within the system. Additionally, Tyler may wish to keep one of his superiors (the Chief Technology Officer, or CTO) informed of progress on the project by allowing the CTO access to the updated file throughout the development of the software product.

As discussed above, Marc has a variety of ways to share the information with Alan and Tyler. Most commonly, Marc would write an email to Alan and Tyler which has an attachment containing the file and text which explains the context of the shared document. In the text, Marc would explain that changes from both Alan and Marc would be incorporated into the document, while Tyler would only be sent updated versions of document. Email is ubiquitous and has a fairly uniform interface and set of actions required to select recipients, attach files, and enter a textual message. Because of the familiarity of people with email and its ease of use, it is a very common method of sharing files and information. However, using standard email as a method of file sharing has a number of disadvantages, including generally low security without awkward external actions, no mechanism for automatically detecting changes or updates to files, no mechanism for detecting conflicts between file versions.

However, Marc, Alan, Tyler and the CTO each have a Simple Cooperative File Sharing System (SCoopFS) resident on their computers (105, 110, 115, 120). According to one illustrative embodiment, Marc uses SCoopFS to select the file he wants to share and securely transfer the file to Alan and Tyler. SCoopFS provides an intuitive email-like interface which allows Marc to identify the shared file, designate the recipients of the file, set file sharing parameters and enter text. After Marc enters the desired information, SCoopFS automatically provides authorization-based security measures and delivers the file to the designated recipients. The SCoopFS system then automatically propagates changes to the shared files among the collaborators.

For example, Marc uses SCoopFS to send a first copy of the file (135) to Alan's computer and a second copy of the file (140) to Tyler's computer (115). As discussed above, there are both active participants and passive observers of the file editing process. Active participants typically expect that changes they make to the document will be propagated to other active participants and the passive observers. Passive observers do not make changes to the document and only expect that their copy of the file will be updated to reflect the current status of the document. In our example, Marc and Alan are active participants and Tyler is a passive observer. The CTO is also a passive observer who derives access through Tyler. Marc expects that Alan will make changes to Alan's copy of the file (135) and wants the original file (125) updated to reflect these changes. Similarly, Alan wants any changes made by Marc to be propagated back to him. Any changes made by Alan to Alan's copy of the file (135) are automatically detected by SCoopFS and propagated to Marc's computer. From Marc's computer, the changes are further propagated to Tyler's computer. If there are conflicts between edits that Marc has made and edits that Alan has made, these conflicts are noted but must be resolved by Alan and Marc. Changes that are made to the original file (125) by Marc are propagated to both Alan's Computer (110) and Tyler's Computer (115). Changes made to Tyler's copy of the file (140) are automatically propagated to the CTO by the SCoopFS system.

In some embodiments, the SCooPFS system may include a responsibility tracking mechanism. Responsibility tracking can be included in the sharing relationship to explicitly specify which party is responsible for changes to the document. For example, Tyler gets an updated copy of the shared file from Marc, even if the changes were made by Alan. Consequently, Tyler holds Marc responsible for the changes. Similarly, the CTO sees the update as coming from Tyler and hold Tyler responsible for those changes. In essence, each sharing relationship is a contract spelling out the rights and responsibilities of the two participants. This contract can be configured or modified in a number ways, including the incorporation of responsibility tracking. In one hypothetical example which illustrates responsibility tracking, the sharing contract specifies a $50 fine for introducing an error into the document. The error is introduced by Alan. The CTO, who receives the document with an error will collect $50 from Tyler. Tyler, in turn will collect $50 from Marc and Marc will collect $50 from Alan. By using responsibility tracking, the relationship flows through the sharing network can be propagated without the requirement for a global understanding of the network.

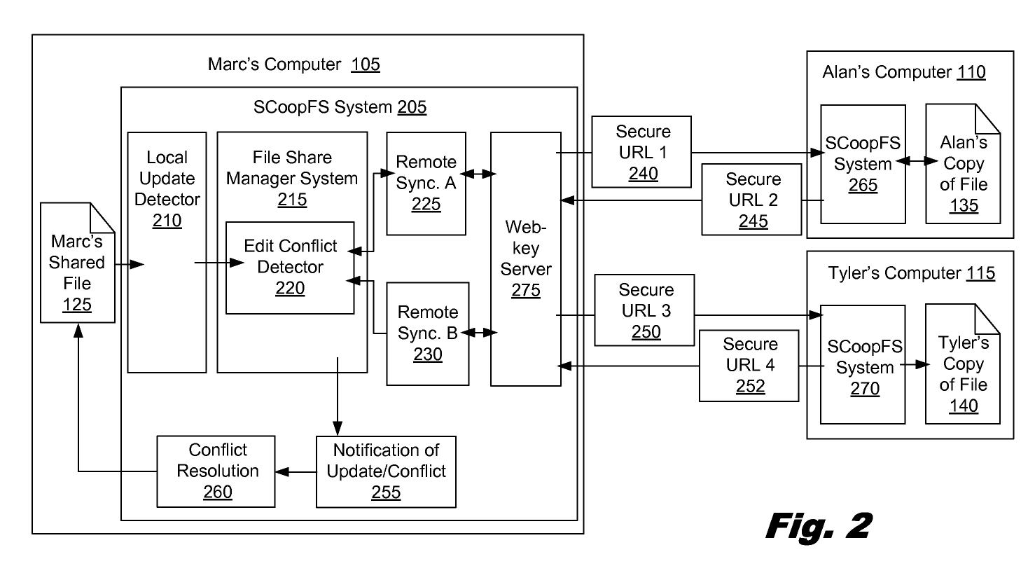

FIG. 2 is a diagram of an illustrative embodiment of the SCoopFS system and its internal components. In FIG. 2, a detailed diagram of a ScoopFS system (205) resident on Marc's Computer (105) is shown. Similar ScoopFS systems (265, 270) are resident on Alan's computer (110) and Tyler's computer (115). For clarity of illustration, the CTO's computer and interactions are not shown in FIG. 2. As discussed above, Marc has designated a file (125) to be shared with both Alan and Tyler. To distribute a copy of Marc's shared file (125), the SCoopFS (205) sends an authorization-based secure link using a web-key convention to each of the intended recipients. The web-key convention uses a securely self-authorizing Uniform Resource Locator (URL), which represents transferable permission to access a file (or take another action) whose location is uniquely identified by the securely self-authorizing URL. According to one illustrative embodiment, these encrypted, server-authenticating, client-authorizing URLs are generated by a web-key server (275) which is incorporated into each ScoopFS system.

Consequently, anyone in possession of the securely self-authorizing URL may request that the server at the location which corresponds to the securely self-authorizing URL take actions on the file. To prevent compromise of the system, the securely self-authorizing URL is specifically generated by the originating system and securely transferred to recipient. There are a variety of methods which are suitable for securely transferring the information to the recipient. For example, the message and securely self-authorizing URL may be transferred using Hyper Text Transfer Protocol Secure Socket Layer (HTTPS) protocol. One potential advantage of using the combination of a securely self-authorizing URL and HTTPS transfer protocol is that the message is able to transparently pass through firewalls and across a wide variety of networks. Upon receipt of the message, the recipient, without using extraneous security software, can cause actions to be taken on the associated file using the securely self-authorizing URL.

According to one illustrative embodiment, the securely self-authorizing URL is generated by including a randomly generated bit string within an https URL. For example, a securely self-authorizing URL may look like: https://oz6awl5hk3ethmvf.example.com/app/#mhbqcmmva5aj3. The random string of characters “mhbqcmmva5aj3,” has a bit string length of at least 64 bits. This provides sufficient protection against a brute force guessing approach to compromising the security of the SCoopFS system. Specifically, if the web application has a maximum throughput of one HTTP request per millisecond, the attacker would have to saturate the web application for almost 300 years to have a 50% chance of guessing the correct bit string

The string of characters “oz6awl5hk3ethmvf.example.com” in the securely self-authorizing URL are the fingerprint of a public key of the machine serving the URL. This fingerprint can be used to verify that the public key used to establish a Secure Socket Layer (SSL) connection with the SCoopFS server corresponds with the fingerprint in the securely self-authorizing URL, thereby assuring the user that the request is going to the desired machine.

Securely self-authorizing URLs may be used communicate in at least two distinct ways: a “pull” system or a “push” system. The SCooPFS system can use a “pull” implementation, a “push” implementation, or a combination of both.

In a “pull” system, the securely self-authorizing URL is sent to from person A to person B. Person B then periodically asks for updates through the securely self-authorizing URL, which corresponds to a location of the shared file or an access point in Person A's system. In this embodiment, the securely self-authorizing URL is used by the person B to “pull” information or updates from person A using the securely self-authorizing URL. The “pull” system uses polling of the remote systems to discover changes within those remote systems.

In a “push” system, the securely self-authorizing URL is sent by the person B to person A. The person A then uses the securely self-authorizing URL to inform the person B about updates or changes which have which have taken place in the shared file resident on person A's system. The “push” system is based on proactively broadcasting changes to remote systems with which there is a sharing relationship. In the illustrative examples that follow, the SCoopFS system will be discussed using “push” implementation.

In the “push” implementation, a message is sent from Marc to Alan which contains both the securely self-authorizing URL 1 (240) and a copy of Marc's shared file (125, FIG. 1). Alan can then directly save the attached copy of Marc's shared file to disk. Alan's computer then uses the securely self-authorizing URL 1 (240) to proactively push changes made by Alan to the shared document back to Marc's computer (105). When Alan has retrieved and saved a copy of Marc's shared file (125) on his own computer or other network location, the SCoopFS system resident on Alan's computer sends securely self-authorizing URL 2 (245) to the SCoopFS system (205) resident on Marc's computer. The securely self-authorizing URL 2 (245) is associated with Alan's copy of the shared file and is used by Marc to push changes made to his copy of the shared file to Alan.

Similarly, the SCoopFS system (205) resident on Marc's computer (105) sends securely self-authorizing URL 3 (250) to Tyler's computer and Tyler's computer responds by sending a securely self-authorizing URL 4 (252) back to Marc's system after Tyler has saved the shared file. Marc can then use the securely self-authorizing URL 4 (252) to push changes made to his copy of the shared file to Tyler. In a push system, the SCoopFS systems reject changes that are broadcast by passive observers. For example, changes made by Tyler are broadcast back to Marc using the secure URL 3 (250), but the changes are rejected by Marc's computer.

Within each SCoopFS system (205, 265, 270), a local update detector (210) monitors the shared files (125, 135) subject to the sharing constraints. For example, the local update detector within Tyler's SCoopFS system will not monitor Tyler's copy of file (140) because Tyler is a passive observer and changes made his copy of the file (140) do not need to be propagated. However, if Tyler shares his copy of the file (140) with the CTO as illustrated in FIG. 1, his local update detector would be activated to push changes to the CTO's SCoopFS system.

Additionally, each SCoopFS system contains a number of remote synchronizer modules (225, 230). These remote synchronizer modules (225, 230) communicate to, and receive changes, from the remote systems via the web-key server (275). According to one illustrative embodiment, there is a remote synchronizer module for each share. For example, a remote synchronizer A (225) receives updates from Alan's SCoopFS system (265) and updates Alan's copy of the file (135) with changes made by Marc. A separate remote synchronizer B (230) passes updates from Marc to Tyler using the securely self-authorizing URL 4 (252) supplied by Tyler's SCoopFS server (270).

The local update detector (210) and remote synchronizer (225, 230) report local or remote changes to a file share manager system (215). As such, both the local update detector (210) and remote synchronizers (225, 230) fulfill synchronization functions. In the specification and appended claims, the term “synchronizer” or “synchronizers” without any additional modifiers refers collectively to the local update detector and remote synchronizers. The share manager (215) may serve a variety of functions including revision management, incorporating changes into the shared file, notification of changes, pushing out local changes to remote systems via the remote synchronizers, or conflict resolution. According to one illustrative embodiment, the file share manager system (215) contains an edit conflict detector (220). The edit conflict detector (220) detects updates and conflicts within the locally saved document and remote documents. For example, the edit conflict detector (220) could compare time stamps or hash codes associated with each document update to determine if the local document (125) had been edited while a remote copy of the document had been edited. If two different versions of the document exist at the same time, the edit conflict detector (220) detects a conflict and sends out a notification of an editing conflict (255). Notifications of updates or change may be sent in a variety of ways. According to one illustrative embodiment, an automatic email may be sent to the user's email notifying them that an update or a conflict has been detected. The user can then open the SCoopFS interface to accept the update or resolve the conflict. In some circumstances the SCoopFS system may include a variety of other methods for notifying users, including instant messaging, text messaging to a mobile device, communicating an audio message, or through other suitable methods. In this way, work performed in editing the document by the various collaborators will not be lost.

In some embodiments, the notification method and frequency may be controlled by the user. For example, a passive user may not wish to receive notification of updates. Instead the SCoopFS system may be configured to automatically apply updates and not send notifications or require user action to apply updates.

A conflict resolution module (260) may also be included to guide the user through the process of resolving the conflict. According to one illustrative embodiment, if there have not been simultaneous, conflicting edits, the file at the other end is automatically updated, and the user receives a notification in his normal email that the file has been updated. If there is a conflict, the user is still notified, but he must go into the SCoopFS system and explicitly resolve the edit conflict. For example, the conflict may be resolved by merging the documents and/or rejecting a portion of the changes which are in direct conflict. In some circumstances the conflict may be resolved automatically. For example, if separate sections of the shared document were edited, an automatic merge could be performed. After conflicts, if any, are resolved, the shared file is updated to reflect the latest changes.

A number of modules which may be included in the SCoopFS system which are not shown in FIG. 2. For example, the SCoopFS system may have a module which tracks various file histories and provides for the opportunity to roll back changes. Other modules such as formatting and input/output modules may also be included in the system. Yet another module may allow convenient sharing of the contents of a directory.

By incorporating a web-key server (275) and using securely self-authorizing URL's, the SCoopFS system provides transparent security for the file sharing process. In contrast to intrusive authentication security measures which challenge the users to identify themselves by supplying such things as user names and passwords, the authorization based security system can operate in the background. Further, the combination of securely self-authorizing URLs and HTTPS protocols allows messages and updates to pass transparently through firewalls and across a wide variety of networks.

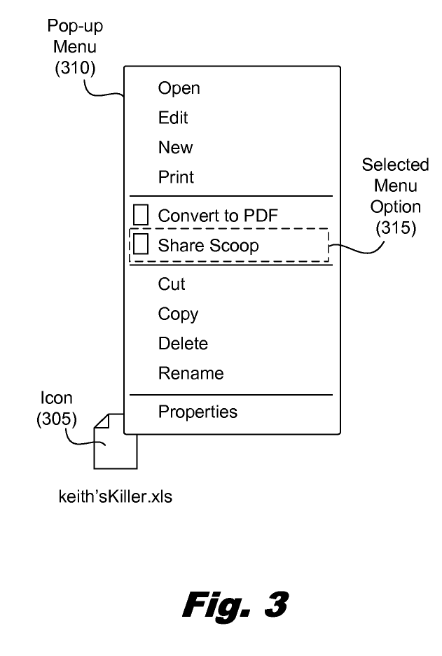

FIG. 3 is a diagram of an illustrative method for initiating intuitive file sharing using the SCoopFS system. According to one embodiment, the user can initiate file sharing using a familiar method for opening and operating on files. For example, the user may select an icon (305) which represents the desired file and then depress the right mouse button to activate a pop-up menu (310). In this example, the name of the file, “keith'sKiller.xls” is listed below the icon (305). Included in the pop-up menu (310) is a menu option labeled “Share Scoop.” FIG. 3 shows the “Share Scoop” menu option (315) selected. By clicking on the “Share Scoop” menu option, the email-like interface to SCoopFS is opened.

The pop-up menu illustrated in FIG. 3 is only one illustrative method for initiating the SCoopFS operation. A variety of other methods could be used, including clicking on an icon directly activates SCoopFS, clicking on a textual file name of the file to be shared, entering the SCoopFS executable on a command prompt, accessing SCoopFS through another program, or other suitable method that allows the user to select the option to share the file or activate the SCoopFS program.

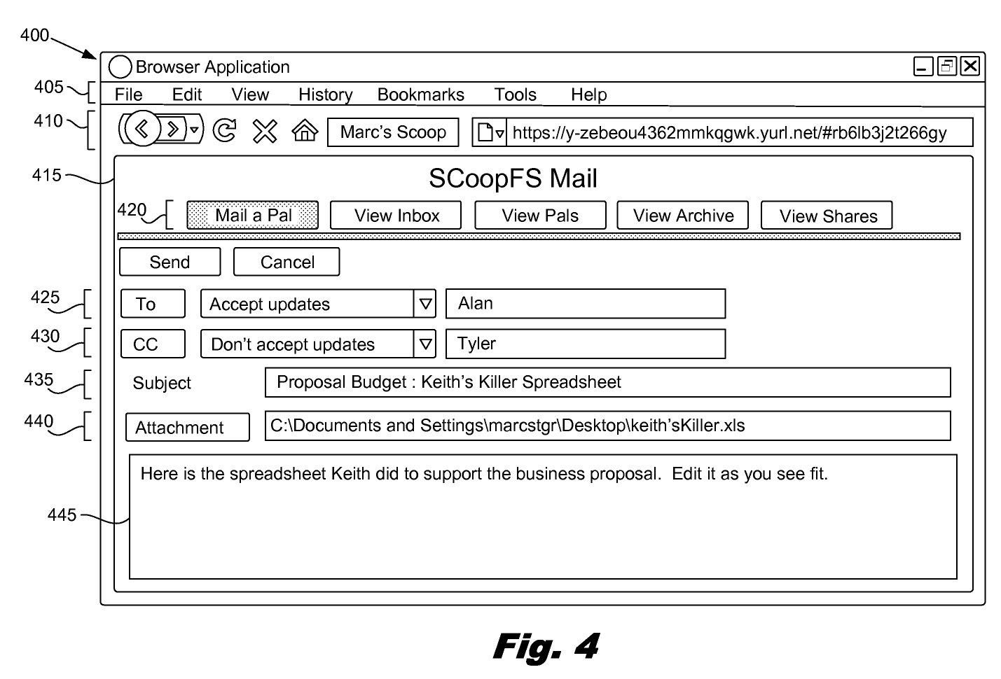

FIG. 4 is an illustrative screen shot of an email-like interface (400) for SCoopFS. According to one illustrative embodiment, SCoopFS may be a browser application or operate within a web browser. In one embodiment, the SCoopFS program makes use of whatever browser is used by the recipient. A web browser is a program which interprets internet language, usually html, and displays it appropriately. Some examples of web browsers include Microsoft's Internet Explorer™ or Mozilla Firefox™. Additionally or alternatively, the SCoopFS program may be configured to operate independent from a third party web browser. For example, the SCoopFS program may interpret and display the html or other internet language in place of the third party web browser.

A typical browser contains menu bar (405) which allows access to relevant commands in a number of categories. Below the menu bar (405), a control menu (410) contains a number of operational and informational elements. For example the illustrative control menu (410) shown in FIG. 4 contains, from left to right: back and forward navigation buttons, a reload page button, a stop loading page button, a go to home page button, the name of the current browser application “Marc's Scoop,” and the securely self-authorizing URL of the page or location which is currently being displayed.

The SCoopFS interface (415) is currently displaying the “SCoopFS Mail” screen which comprises a menu bar (420) which includes buttons for performing a number of operations within the SCoopFS interface (415). According to one illustrative embodiment, the buttons include the “Mail a Pal” button, which is currently activated; a “View Inbox” button; a “View Pals” button, which may be analogous to a “manage contacts” interface in an email application; a “View Archive” button, and a “View Shares” button. Each of these buttons displays a different screen within the SCoopFS interface.

The SCoopFS Mail page has a number of similarities with conventional email interfaces. This leverages the ubiquitous nature of email systems and allows users familiar with sending email to intuitively use the SCoopFS interface. For example, the interface includes a “Send” button which would send a completed message and a “Cancel” button which would empty the fields and prevent the message from sent. A “To” line (425) allows the user to designate the desired sharing mode and the person or entity with which the file is to be shared. A “CC” line similarly allows a user to designate additional recipients of the shared file. In the example of FIG. 4, the “To” line (425) has a sharing mode of “Accept updates” and has designated “Alan” as a recipient. The “CC” line (430) has a sharing mode of “Don't accept updates” and a recipient of “Tyler.” While the figure only shows space for one person, the program could allow the user to set multiple names of people to send the file to here. According to one illustrative embodiment, the desired sharing mode can be selected from a drop down menu. The options for the sharing mode may include: “Accept updates,” indicating an active relationship with two way communication; “Don't accept updates” indicating a passive relationship where changes to the original shared document are sent to the recipient, but changes made by the recipient are not returned; “Manual Update” indicating that some action by the user required before an update is transferred; and “No Update” indicating that the file is only sent once. As will be shown below, the sharing mode can changed to reflect dynamic relationships between the various entities.

A subject line (435) allows for a title to be given to the communication. In the illustrative example shown in FIG. 4, the subject is “Proposal Budget: Keith's Killer Spreadsheet.” Below the subject line (435), an attachment line (440) is shown. The attachment line (440) shows the current file which as been designated as the shared file. In this case, the shared file has been identified by showing its file path which includes its location with the hierarchal file structure on the initiator's machine and the name of the file. In cases where the file sharing is initiated using a method similar to that shown in FIG. 3, the attachment field may already be filled out. In other circumstances, the “Attachment” button may be selected and a file navigator window will open to allow the user to browse through the file structure and select the desired file. A text box (445) allows for a textual message to be entered by the user. The textual message may include background relating the shared file, instructions about what action is to be taken by the recipient or other desired information. Thus, FIG. 4 simulates actions by Marc to share a file named “keith'sKiller.xls” with an active participant, Alan, and a passive participant, Tyler. The file “keith'sKiller.xls” may be a budget proposal for a project that Marc and Alan are jointly working on. Tyler may be a coworker who has a vested interest in the success of the project but doesn't have time to be actively involved.

When the user presses the “Send” button, the message, with the file attachment, is sent using web-key protocol, so that it is properly encrypted, authorized, and authenticated (unlike most normal email). According to one illustrative embodiment, a notification is placed in the recipient's normal email inbox (“you have received a SCoopFS message”). The recipient then clicks on his bookmarked URL for his SCoopFS mailbox, which brings up his web browser on SCoopFS, which has an email-like view of his SCoopFS inbox. This inbox now includes an entry for the message and its attachment.

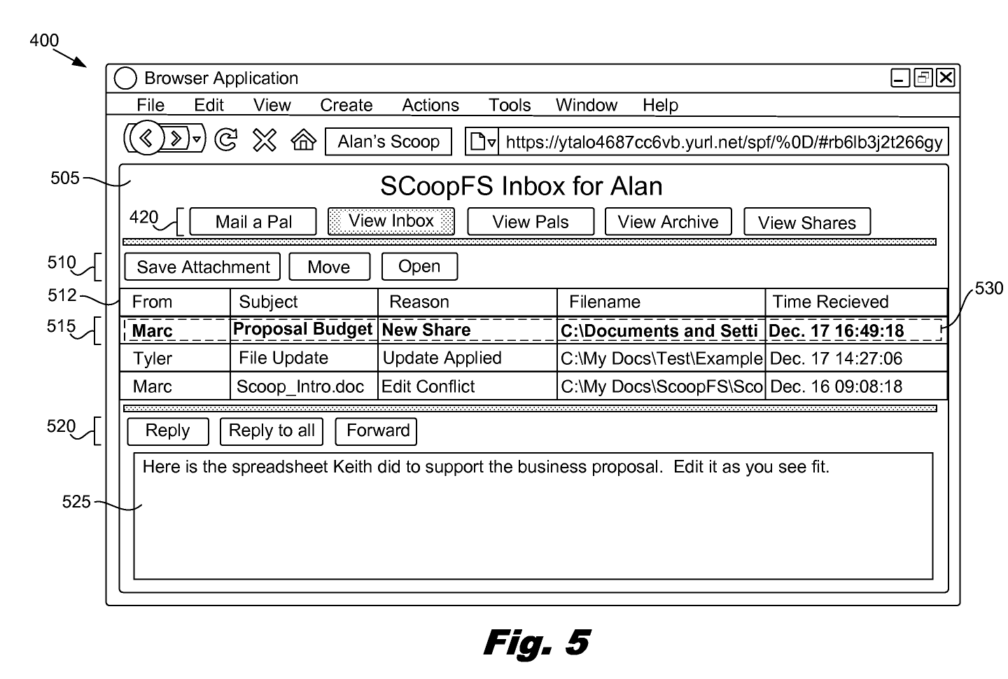

FIG. 5 is an illustrative screen shot which shows Alan's SCoopFS Inbox (505). For example, the “inbox” may include a list of all the received messages, with the messages that have yet to be viewed in bold. On top of the list of messages will be the most recent file share message. The SCoopFS menu bar (420) indicates that “View Inbox” button has been selected. According to one illustrative embodiment, the SCoopFS Inbox (505) displays notifications of actions taken within the SCoopFS system, conflicts which may have arisen, and new file shares which the system has received. There may be a number of control buttons (510) which allow the user (Alan) to maintain the inbox (505) and perform the desired operations on the various entries. For example, a “Save Attachment” button may bring up a file navigator which allows Alan to select the desired location to save the attached file. When choosing where to save the file, a browser window opens up allowing the user to browse through the file system on their machine and decide exactly what location to place the file. For example, the recipient may choose to save the file on their local machine, within a central repository, on a network drive, or in a remote location. This process is similar to downloading attachments in a regular email application. A “Move” button may similarly bring up a navigator which allows Alan to move or organize inbox notifications. An “Open” button may allow Alan to open the attachment or open the message to obtain more extensive information.

Below the control buttons (510), a table (512) which contains a number of notifications is shown. The first notification (515) corresponds to the file share generated by Marc in FIG. 4. The notification (515) includes who the file share is from (Marc), the subject of the file share (Proposal Budget), the reason that SCoopFS is showing the notification (New Share), the filename of the shared file, and the time the new share was received. The SCoopFS system may be configured to display a notification for a variety of reasons including new file shares, the application of an update, or because an editing conflict has been detected which needs to be resolved by the user.

Under the notification table, a number of response buttons may be displayed. These response buttons may include standard email actions such as “Reply,” “Reply to All,” and “Forward.” A text box (525) displays the text of the selected message. In FIG. 5 Marc's “Proposal Budget” message (515) is selected and the related text is displayed in the text box (525).

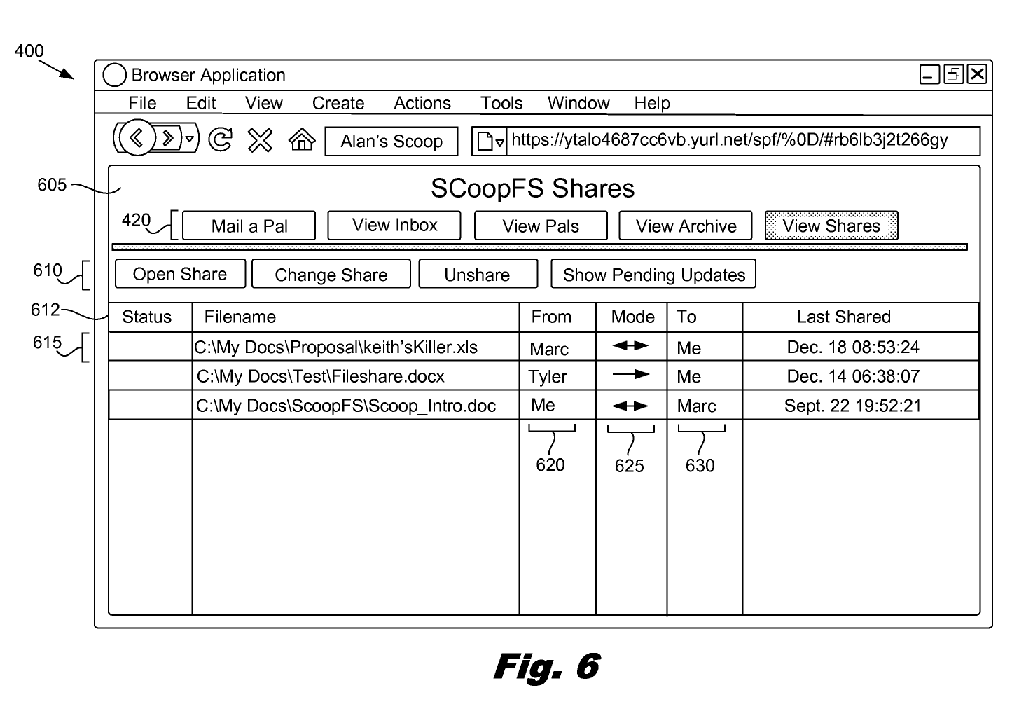

FIG. 6 is an illustrative screen shot which shows active file shares for Alan's SCoopFS system. The SCoopFS Shares screen (605) includes the menu bar (420) with the “View Shares” button selected. Below the menu bar (420), control buttons (610) allow the user to perform various operations on shares listed in the share table (612). For example, the control buttons may include options to: “Open Share,” which will open a selected share and display various information about the share, such as share history and configuration; “Change Share,” which will allow the user to change share modes or other configuration; “Unshare,” which will allow the user to selectively break the shares with one or more entities; and “Show Pending Updates” which shows only shares with changes which have not yet been accepted and/or sent.

The share table (612) may list all or portion of pending shares for a given user. According to one illustrative embodiment, each line of the share table lists an individual file share. For example, the first line (615) contains an entry for “keith'sKiller.xls” which Alan has saved locally at “C:\My Docs\Proposal\keith'sKiller.xls.” The first line (615) also shows who the share originated with (“Marc”), the share mode, and who the file share is to (“Me”). In this embodiment, arrows are used to graphically illustrate the share mode and the relationship established between the “From” and “To” entities. For example, a double arrow shows an active relationship with changes to the documents flowing in both directions. A single headed arrow shows a passive relationship, where changes are originate at the “From” entity and propagated to the “To” entity.

According to one illustrative embodiment, the SCoopFS system has a separate entry for each share with each individual entity. For example, a user may share a first file with six colleagues and a second file with 4 colleagues. This would be displayed as 10 individual entries within the share table. This allows each sharing relationship to be managed individually and also follows the underlying functionality of a unique securely self-authorizing URL assigned to each share for each individual and using a separate remote synchronizer for each sharing relationship. Consequently, during the evolution of a project or management cycle, the shares can be individually monitored and adjusted. For example, breaking a sharing relationship with a colleague who has been transferred off a project is a simple matter and leaves the remaining file shares in place.

By using an email metaphor in the interface design for the SCoopFS system, the existing and ubiquitous understanding of email interfaces can provide an intuitive method for sharing files. Because email is perhaps the most common method of sharing files, most users will naturally understand and use the SCoopFS interface. As discussed above, the email metaphor in the SCoopFS system may include concepts such as “To” and “From” fields, attachments, Inboxes, address books, managing contacts, moving messages, and other email-like functions. When the intuitive SCoopFS interface is coupled with transparent security functions provided by the web-key protocols, the barrier to using the SCoopFS file system can be almost negligible for most computer users.

A variety of other familiar metaphors could be used to provide intuition for the users. For example, metaphors could be drawn from social networking, instant messaging, file access interfaces, or drag-and-drop file placement.

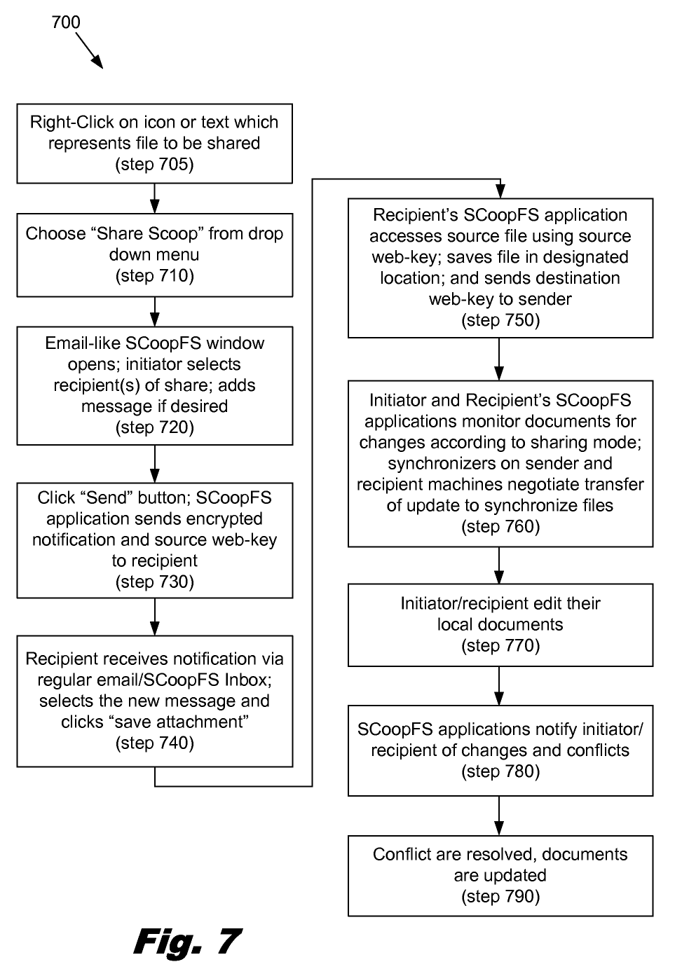

FIG. 7 is an illustrative method for intuitive file sharing (700) with transparent security. In a first step, the initiator right-clicks on an icon or text which represents the file to be shared (the “shared file”) (step 705). As discussed above, the file could be selected in a variety of other ways. A pop-up menu is then displayed and the “Share Scoop” entry is selected (step 710). The SCoopFS interface opens to an email-like Mail screen where the initiator can select recipient(s) of the share, enter a message, and set the share parameters (step 720). The initiator then selects the option to “send” the message; SCoopFS application sends the message and a securely self-authorizing URL via a secure channel (typically through an HTTPS protocol) (step 730). The recipient receives the notification via regular email and/or in a SCoopFS Inbox. The recipient selects the new message and selects an option to “save attachment” (step 740).

In a “push” implementation, the recipient sends a securely self-authorizing URL back to the initiator. The initiator would then “push” updates to the recipient using the securely self-authorizing URL received from the recipient. If the recipient is an active participant in the process, the recipient will push update to the recipient's shared file back to the initiator using the securely self-authorizing URL received from the initiator.

The initiator and recipient then make changes to their local documents (step 770). The SCoopFS applications notify the initiator and/or the recipient of the changes and conflicts which arise during the editing process (step 780). The conflicts, if any, are resolved and the files are updated (step 790).

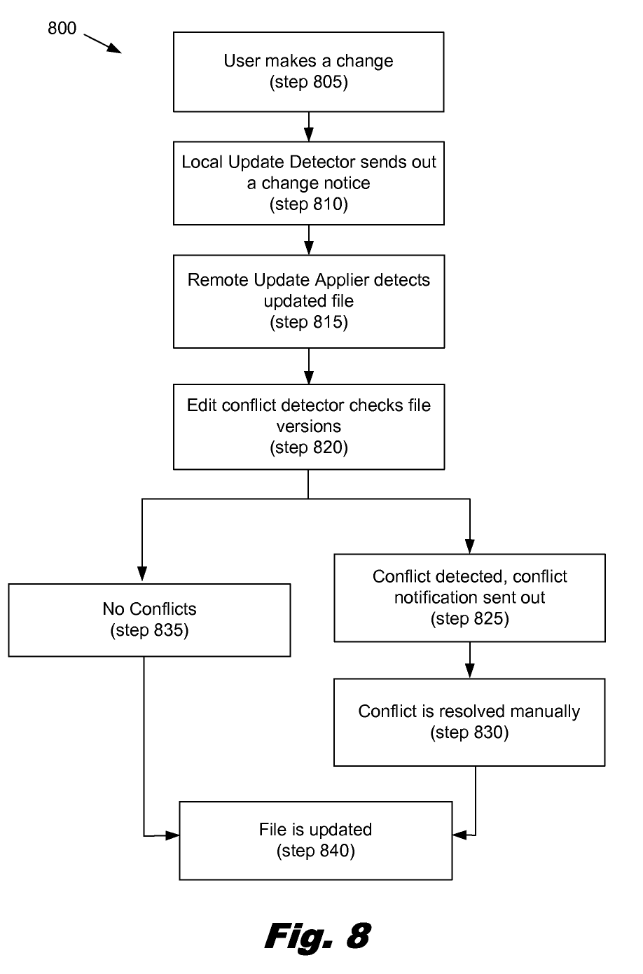

FIG. 8 is a flow chart which shows an illustrative method (800) for identifying and resolving conflicts within a SCoopFS system. In a first step a user (either the initiator or one of the recipients) makes a change to the document (step 805). The local update detector within the user's SCoopFS system detects the change and pushes out a change notice (step 810) to the other party's system. The other party's remote synchronizer detects the change notice and retrieves the updated file (step 815). The edit conflict detector checks the file version (step 820). If no conflict is detected (step 835), then the file is updated (step 840).

However, if a conflict in the various versions and/or within the edits is detected, a conflict notification is sent out (step 825). According to one illustrative embodiment, the conflict is resolved manually (step 830). Additionally or alternatively, a portion of the conflicts may be resolved automatically using programmed logic to reconcile and merge the changes within the two conflicting documents. Following the successful resolution of the changes within the documents, the file is then updated (step 840).

In sum, an intuitive file sharing program with transparent security provides a number of advantages. For example, by using authorization-based security, such as web-key protocols, the security of the shared files can be significantly improved and intrusive authentication-based queries eliminated. Further, by using securely self-authorizing URLs which are associated with a shared file, the synchronized file copies can be saved anywhere on the user's system. Synchronizers which operate in the background of the system automatically propagate updates, check for editing conflicts, escalate issues, and provide for scalable networking.

By using an email metaphor in the interface design for the file sharing system, the ubiquitous use of email can be leveraged to provide most computer users with an intuitive understanding of the file sharing system interfaces. The file sharing system also has the ability to engage in “rich” sharing, including “chained attenuation.” Each sharee can further share (just as they can using email) any limited set of access rights they have up to the set of all the access rights they have. Similar to maintaining an email address book, the users can create and maintain individual sharing relationships which can be separately tailored the specific circumstances and modified without disrupting other sharing relationships. When this intuitive interface is coupled with authorization based security, the barrier to using the file sharing system can be almost negligible for most computer users.

Although the SCoopFS system is used as an illustrative example of an intuitive file sharing program with transparent security, the disclosure is not limited to the specific names, features, systems, or methods described in relationship to the SCoopFS system. One of skill in the art will appreciate that the preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A file sharing system comprising:
authorization-based security to control access to shared files; and
a synchronizer which uses said authorization-based security to propagate changes made to said shared files.

2. The file sharing system of claim 1, wherein said authorization-based security comprises a securely self-authorizing URL.

3. The file sharing system of claim 1, wherein said securely self-authorizing URL is generated and used according to a web-key convention, said securely self-authorizing URL being generated, transmitted, and used to access said shared file without requiring the entry of authentication information by a human user.

4. The file sharing system of claim 1, further comprising a user interface which uses an email metaphor.

5. The file sharing system of claim 4, wherein said user interface includes at least one of: a “To” field for designating recipients of a shared file; an attachment field for designating a said shared file; an “Inbox” for receiving notification of events relating to said shared files.

6. The file sharing system of claim 1, wherein said synchronizers operate in the background of said file sharing system to detect remote and local changes to said shared files.

7. The file sharing system of claim 6, wherein separate remote synchronizers are used to manage each file share.

8. The file sharing system of claim 6, wherein said synchronizers report changes to remote and local shared files to a file share manager, the file share manager detecting and assisting said user in resolving editing conflicts.

9. A file sharing system comprising:
a user interface which uses an email metaphor for creating file sharing relationships;
securely self-authorizing URLs which provide authorization-based access to shared files;
synchronizers which operate in the background of said file sharing system to detect changes to said shared files; and
a file share manager which detects editing conflicts.

10. A method for file sharing comprising:
using authorization-based security to control access to a shared file; and
monitoring said shared file for changes using a synchronizer which uses said authorization-based security to transmit updates to said shared file.

11. The method of claim 10, further comprising:
identifying a file controlled by an initiator which is to be a shared file;
opening a file sharing program, said file sharing program having an email-like interface for creating and managing file sharing relationships;
designating a recipient of said shared file in a first field;
designating said shared file in a second field;
generating a securely self-authorizing URL which is associated with said shared file; and
sending a message to said recipient, said message comprising said securely self-authorizing URL.

12. The method of claim 11, further comprising:
said recipient receiving said message;
said recipient using said securely self-authorizing URL to access said shared file
said recipient replicating said shared file; and
said recipient returning a second securely self-authorizing URL to an originating system of said shared file, said second securely self-authorizing URL being associated with a replication of said shared file by said recipient, said second securely self-authorizing URL providing authorization based ability to request that changes be made to said replication of said shared file.

13. The method of claim 12, further comprising:
monitoring said shared file and replications of said shared file using a synchronizer which detect changes in said shared file and replications of said shared file;
propagating said changes based on a defined sharing relationship between said initiator and said recipient; and
controlling acceptance of updates according to said defined sharing relationship.

14. The method of claim 11, further comprising sending a securely self-authorizing URL to a recipient, said secure self-authorizing URL being used for sending updates within a pull file sharing system.

15. The method of claim 11, further comprising: sending a securely self-authorizing URL to a recipient, said secure self-authorizing URL being used for receiving in a push file sharing system.
